(19) United States
(12) Patent Application Publication
(10) Pub. No.: US 2024/0381497 A1
(43) Pub. Date: Nov. 14, 2024

(54) COOKING APPLIANCE

(71) Applicant: LG ELECTRONICS INC., Seoul (KR)

(72) Inventors: Younghwan KWACK, Seoul (KR); Seongho SON, Seoul (KR); Jongseong JI, Seoul (KR)

(73) Assignee: LG ELECTRONICS INC., Seoul (KR)

(21) Appl. No.: 18/660,674

(22) Filed: May 10, 2024

(30) Foreign Application Priority Data
May 11, 2023 (KR) 10-2023-0061295

(51) Int. Cl. H05B 6/40; H05B 6/04; H05B 6/06; H05B 6/12

(52) U.S. Cl. CPC H05B 6/40; H05B 6/04; H05B 6/065; H05B 6/1218; H05B 6/1272; H05B 6/1281; H05B 2213/05; H05B 2213/07

(57) ABSTRACT

A cooking appliance can include a top plate configured to support an object to be heated, a plurality of working coils configured to heat the object, a plurality of inverters configured to apply current to at least one of the plurality of working coils, and a controller configured to heat the object via at least one heating area among a first heating area, a second heating area and a third heating area, in which the first heating area corresponds to at least a first working coil among the plurality of working coils, the second heating area corresponds to at least a second working coil among the plurality of working coils, and the third heating area corresponds to a third working coil among the plurality of working coils.

### CROSS-REFERENCE TO RELATED APPLICATIONS

The present application claims priority under 35 U.S.C. 119 and 35 U.S.C. 365 to Korean Patent Application No. 10-2023-0061295 filed in the Republic of Korea on May 11, 2023, the entirety of which is hereby incorporated by reference into the present application.

### BACKGROUND

The present disclosure relates to a cooking appliance. More specifically, the present disclosure relates to a cooking appliance capable of heating both magnetic and non-magnetic objects.

Various types of cooking appliances are used to heat food at home or in the restaurant. According to the related art, a gas stove using gas as a fuel has been widely used. However, recently, devices for heating an object to be heated, for example, a cooking container such as a pot, have been spread using electricity instead of gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating object such as silicon carbide to the object to be heated (e.g., a cooking container) through radiation or conduction. In addition, when high-frequency power of a predetermined magnitude is applied to the coil, the induction heating method generates an eddy current in the object to be heated consisting of a metal component using a magnetic field generated around the coil to heat the object to be heated itself.

Recently, the induction heating method is mainly applied to cooking appliances.

However, such cooking appliances have a limitation in that the heating efficiency for non-magnetic containers is very low, compared to the heating efficiency for magnetic containers. Accordingly, in order to improve the problem of very low heating efficiency for non-magnetic objects (e.g., heat-resistant glass, pottery, etc.), cooking appliances can include an intermediate heater to which an eddy current is applied, to heat non-magnetic objects.

However, in a case where the cooking appliance is provided with an intermediate heater, when heating a magnetic container, a portion of a magnetic field combines with the intermediate heater to indirectly heat the magnetic container before reaching the magnetic container. Accordingly, there is a problem in that heating efficiency is somewhat reduced. Furthermore, additional coils or inverters are required to control heat generation of the intermediate heater. Accordingly, there is a problem in that costs increase and the control process as well as the structure of the cooking appliance becomes complicated.

### SUMMARY OF THE DISCLOSURE

The present disclosure provides a cooking appliance that is capable of heating all magnetic, non-magnetic, and non-metal containers, regardless of the material of the container.

The present disclosure provides a cooking appliance that allows an intermediate heater to generate heat by using an existing working coil and inverter, without adding a separate working coil and inverter.

The present disclosure provides a cooking appliance that includes an intermediate heater in various patterns according to the arrangement of a working coil.

The present disclosure provides a cooking appliance that minimizes the problem of reduced heating efficiency by minimizing heat generation from an intermediate heater when heating a magnetic container.

The present disclosure provides a hidden crater that is capable of heating a non-magnetic container in a specific area of a cooking appliance.

The present disclosure improves use convenience by providing a cooking appliance that, when a hidden crater is activated, identifies the hidden crater.

A cooking appliance according to at least one of various embodiments of the present disclosure can include a top plate on which an object to be heated is placed, a plurality of working coils configured to heat the object to be heated, a plurality of inverters configured to apply current to at least one of the plurality of working coils, and a controller configured to perform control to heat the object to be heated through at least one heating area among a first heating area and a second heating area each formed by the plurality of working coils and a third heating area formed at a location overlapping at least one of the plurality of working coils for the first heating area and at least one of the plurality of working coils for the second heating area.

A cooking appliance according to at least one of various embodiments of the present disclosure can include a top plate on which an object to be heated is placed, a plurality of working coils configured to heat the object to be heated, a plurality of inverters configured to apply current to at least one of the plurality of working coils, and a controller configured to perform control to heat the object to be heated through at least one heating area among a first heating area and a second heating area each formed by the plurality of working coils and a third heating area including a portion of the first heating area and a portion of the second heating area.

The cooking appliance according to at least one of various embodiments of the present disclosure can further include an intermediate heater disposed on the third heating area.

In the cooking appliance according to at least one of various embodiments of the present disclosure, the intermediate heater can be coated on the top plate corresponding to the formed third heating area.

In the cooking appliance according to at least one of various embodiments of the present disclosure, the controller can be configured to control an operation of each of the plurality of inverters that applies current to each of the plurality of working coils for the third heating area such that the plurality of working coils operate in same phase as each other.

The cooking appliance according to at least one of various embodiments of the present disclosure can further include a relay configured to perform a switching operation between each of the plurality of working coils for the third heating area and another working coil configured to receive current from the same inverter.

In the cooking appliance according to at least one of various embodiments of the present disclosure, when the third heating area is activated, the controller is configured to control the relay such that current is not applied to other working coils configured to receive current from the same inverter as each of the plurality of working coils for the third heating area.

In the cooking appliance according to at least one of various embodiments of the present disclosure, the plurality of working coils for the third heating area can be configured to receive current from different inverters.

In the cooking appliance according to at least one of various embodiments of the present disclosure, the plurality of working coils for the third heating area can be configured to receive current from individual inverters.

In the cooking appliance according to at least one of various embodiments of the present disclosure, the controller can be configured to perform control such that the inverters configured to apply current to the plurality of working coils forming the third heating area operate in same operating frequency having opposite phases.

In the cooking appliance according to at least one of various embodiments of the present disclosure, the controller can be configured to identify a location where the object to be heated is placed and determine whether the identified location corresponds to the third heating area.

The cooking appliance according to at least one of various embodiments of the present disclosure can further include an indicator disposed around the plurality of coils and configured to emit light under the control of the controller.

The cooking appliance according to at least one of various embodiments of the present disclosure can further include a diffusion plate disposed between the top plate and the indicator and extending up to the top plate in a longitudinal direction to diffuse the emitted light such that the emitted light is exposed to the outside through the top plate.

In the cooking appliance according to at least one of various embodiments of the present disclosure, the indicator can be disposed around at least one working coil forming the third heating area.

In the cooking appliance according to at least one of various embodiments of the present disclosure, the indicator can include a light emitting diode (LED) element, an LED array, and a speaker.

A cooking appliance according to at least one of various embodiments of the present disclosure can include a top plate on which an object to be heated is placed, a plurality of working coils configured to heat the object to be heated, a plurality of inverters configured to apply current to at least one of the plurality of working coils, and a controller configured to perform control to heat the object to be heated through at least one heating area among a first heating area and a second heating area each formed by the plurality of working coils and a third heating area including a portion of the first heating area and a portion of the second heating area.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a perspective view illustrating a cooking appliance according to an embodiment of the present disclosure.

FIG. 2 is a circuit diagram of a cooking appliance according to an embodiment of the present disclosure.

FIG. 3 is a circuit diagram of an inverter for a working coil of a cooking appliance according to an embodiment of the present disclosure.

FIG. 4 is a cross-sectional view illustrating a cooking appliance and an object to be heated according to an embodiment of the present disclosure.

FIG. 5 is a cross-sectional view illustrating a cooking appliance and an object to be heated according to another embodiment of the present disclosure.

FIGS. 6 to 14 are diagrams for describing a hidden heating area according to one or more embodiments of the present disclosure.

FIG. 15, including parts (a)-(e), is a diagram illustrating an object to be heated, which is disposed on a cooking appliance according to an embodiment of the present disclosure.

FIG. 16, including parts (a)-(i), is a diagram for describing a top view of heating areas including a hidden heating area according to an embodiment of the present disclosure.

FIG. 17, including parts (a)-(c), is a diagram for describing a method for identifying a hidden heating area formed in a cooking appliance according to an embodiment of the present disclosure.

FIGS. 18 to 23 are cross-sectional views illustrating a cooking appliance including an indicator according to one or more embodiments of the present disclosure.

FIG. 24, including parts (a) and (b), is a diagram illustrating a movable intermediate heater according to one or more embodiments of the present disclosure.

### DETAILED DESCRIPTION OF THE EMBODIMENTS

Hereinafter, preferred embodiments of the present disclosure will be described in detail with reference to the accompanying drawings. Throughout the drawings, the same reference numerals are used to indicate the same or similar components.

The suffixes “module” and “unit” for components used in the description below are assigned or mixed in consideration of easiness in writing the specification and do not have distinctive meanings or roles by themselves.

In the following description, the term “connection” between elements includes not only direct connection between the elements, but also indirect connection between the elements through at least one other element, unless otherwise specified.

The features of various embodiments of the present disclosure can be partially or entirely coupled to or combined with each other and can be interlocked and operated in technically various ways, and the embodiments can be carried out independently of or in association with each other.

Hereinafter, a cooking appliance and an operating method thereof according to an embodiment of the present disclosure will be described. Meanwhile, in the present disclosure, the cooking appliance can be an induction heating type cooktop, but is not limited thereto.

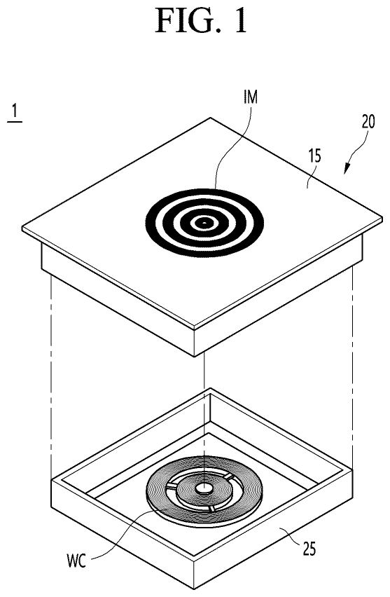

FIG. 1 is a perspective view illustrating a cooking appliance 1 according to an embodiment of the present disclosure.

Referring to FIG. 1, the cooking appliance 1 according to an embodiment of the present disclosure can include a case 25, a cover plate 20, and a working coil WC. The cooking appliance 1 can further include an intermediate heater IM. However, the present disclosure is not limited thereto.

The working coil WC can be installed in the case 25.

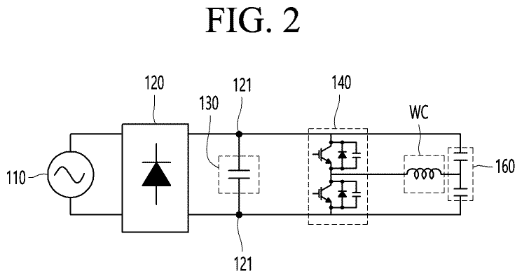

In addition to the working coil WC, various devices related to the driving of the working coil WC can be installed in the case 25. The various devices can include, for example, one or more of a power supply (see 110 of FIG. 2) that provides alternating current (AC) power, a rectifier (see 120 of FIG. 2) that rectifies AC power of the power supply into direct current (DC) power, an inverter (see 140 of FIG. 2) that converts DC power rectified by the rectifier into a resonance current through a switching operation and supplies the resonance current to the working coil WC, and a control module that controls the operations of various devices in the cooking appliance 1.

The cover plate 20 can include a top plate 15 coupled to the top of the case 25 and having a top surface on which an object to be heated, such as a cooking container, is placed.

The top plate 15 can be made of a glass material such as ceramic glass, but this is only an example. The material of the top plate 15 according to the embodiment of the present disclosure can vary.

In addition, the top plate 15 can include an input interface that transmits a user input to an input interface control module. The input interface can be provided in a location other than the top plate 15.

The input interface is a module for receiving a user input, such as desired heating intensity or operating time of the cooking appliance 1, and can be implemented as a physical button or a touch panel. The input interface can further include a power button, a lock button, a power level control button (+, −), a timer control button (+, −), a charging mode button, etc. The input interface control module can transmit a user input to the above-described control module (e.g., an inverter control module). Since the above-described control module can control the operations of various devices (e.g., the working coil WC) based on the user input, detailed descriptions thereof are omitted.

Whether the working coil WC is driven and the heating intensity (i.e., heating power) can be visually displayed in a crater shape on the top plate 15. The crater shape can be displayed by an indicator composed of a plurality of light emitting devices (e.g., light emitting diodes (LEDs)) provided in the case 25. The crater shape can have a circular shape or a shape including one or more ring shapes corresponding to a heating area.

The working coil WC can be installed inside the case 25 to heat the object to be heated.

The driving coil WC can be controlled by the above-described control module. For example, when the object to be heated is placed on the top plate 15, the working coil WC can be driven by the control module.

The working coil WC can directly heat a magnetic object to be heated (that is, a magnetic object) and can also indirectly heat a non-magnetic object to be heated (that is, a non-magnetic object) through the intermediate heater IM.

The working coil WC can heat the object to be heated by an induction heating method and can be provided to overlap the intermediate heater IM in the longitudinal direction (i.e., the vertical direction or the up-and-down direction).

Although it is illustrated in FIG. 1 that one working coil WC is installed in the case 25, the present disclosure is not limited thereto. That is, a plurality of working coils WC can be installed in the case 25. The intermediate heater IM can be installed to correspond to the working coil WC.

The intermediate heater IM can be installed on the top plate 15. The intermediate heater IM can be coated on the top plate 15 to heat a non-magnetic object among the objects to be heated. The intermediate heater IM can be inductively heated by the working coil WC.

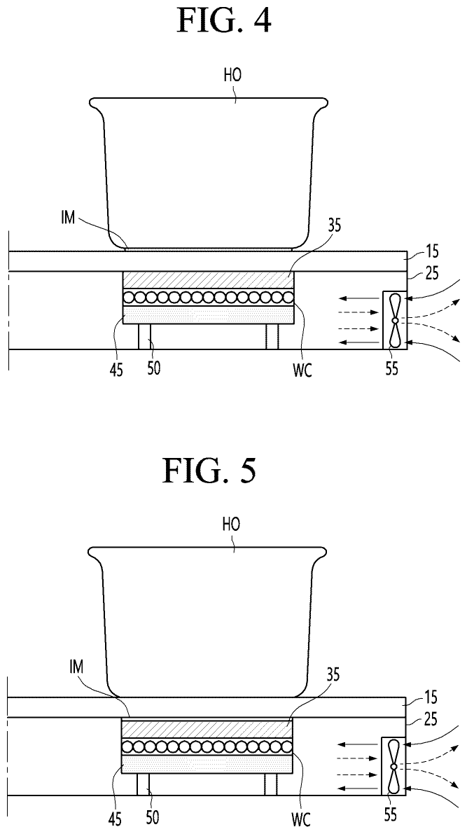

The intermediate heater IM can be formed on the top or bottom surface of the top plate 15. For example, the intermediate heater IM can be installed on the top surface of the top plate 15 as illustrated in FIG. 4, or can be installed on the bottom surface of the top plate 15 as illustrated in FIG. 5.

The intermediate heater IM can be provided to overlap at least a portion of the working coil WC in the longitudinal direction (i.e., the vertical direction or the up-and-down direction). Therefore, the object to be heated can be heated through the working coil WC and the intermediate heater IM, regardless of the type and arrangement of the object.

The intermediate heater IM can have at least one of magnetic and non-magnetic characteristics (i.e., magnetic characteristics, non-magnetic characteristics, or both magnetic and non-magnetic characteristics).

The intermediate heater IM can be made of a conductive material such as aluminum (Al), but is not limited thereto. In other words, the intermediate heater IM can be made of a material other than a conductive material.

It is illustrated in FIG. 1 that the intermediate heater IM has a shape in which a plurality of rings of different diameters are repeated, but the intermediate heater IM is not limited thereto and can have other shapes.

FIGS. 1 and 4 to 6 illustrate one intermediate heater IM, but the intermediate heater IM can be provided in plurality.

FIG. 2 is a circuit diagram of a cooking appliance 1 according to an embodiment of the present disclosure.

Referring to FIG. 2, the cooking appliance 1 can include all or part of a power supply 110, a rectifier 120, a DC link capacitor 130, an inverter 140, a working coil WC, and a resonance capacitor 160.

The power supply 110 can receive external power, for example, AC power, and supply an AC voltage to the rectifier 120.

The rectifier 120 is an electrical device that converts AC into DC. The rectifier 120 can convert an AC voltage supplied through the power supply 110 into a DC voltage and supply the converted voltage to two DC terminals 121.

An output terminal of the rectifier 120 can be connected to the two DC terminals 121. The two DC terminals 121 output through the rectifier 120 can be referred to as a ‘DC link’. A voltage measured across the two DC terminals 121 is referred to as a ‘DC link voltage’.

The DC link capacitor 130 serves as a buffer between the power supply 110 and the inverter 140. Specifically, the DC link capacitor 130 can maintain the DC link voltage converted through the rectifier 120 and supply the DC link voltage to the inverter 140.

The inverter 140 can switch a voltage applied to the working coil WC so that a high-frequency current flows through the working coil WC. The inverter 140 can apply current to the working coil WC. The inverter 140 can include a relay or a semiconductor switch that turns on or off the working coil WC. For example, the semiconductor switch can include an insulated gate bipolar transistor (IGBT) or a wide band gap (WBG) device. The WBG device can include silicon carbide (SiC) or gallium nitride (GaN). The inverter 140 drives the semiconductor switch to cause a high-frequency current to flow in the working coil WC, thereby forming a high-frequency magnetic field in the working coil WC.

The working coil WC can include at least one working coil WC that generates a magnetic field for heating the object to be heated HO. Current may or may not flow through the working coil WC depending on whether the switching element is driven. When current flows through the working coil WC, a magnetic field is formed. The working coil WC can heat the cooking appliance 1 by generating a magnetic field as the current flows.

One side of the working coil WC can be connected to a connection point of the switching element of the inverter 140, and the other side of the working coil WC can be connected to the resonance capacitor 160.

The driving of the switching element can be performed by a driver and can be controlled at a switching time output from the driver to apply a high-frequency voltage to the working coil WC while the switching elements alternately operate with each other. Since the on/off time of the switching element applied from the driver is controlled in a gradually compensated manner, the voltage supplied to the working coil WC can change from a low voltage to a high voltage.

The resonance capacitor 160 can resonate with the working coil WC.

The resonance capacitor 160 can be a component for serving as a buffer. The resonance capacitor 160 affects energy loss for the turn-off time by adjusting a saturation voltage rise rate during the turn-off of the switching element.

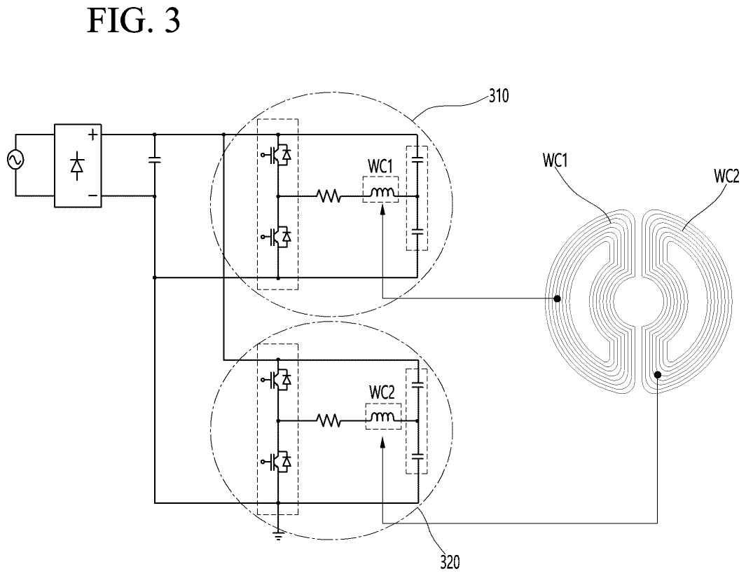

FIG. 3 is a circuit diagram of a cooking appliance 1 according to an embodiment of the present disclosure.

It can be said that, if FIG. 2 is a circuit diagram of the cooking appliance 1 that forms one crater by using one working coil WC, FIG. 3 is a circuit diagram of the cooking appliance 1 that forms one crater by using two working coils WC1 and WC2.

A working coil driver for driving one working coil WC in FIG. 2 can be provided for each of the working coils WC1 and WC2 in FIG. 3. The working coil driver as used herein can mean including, for example, an inverter, a working coil WC, and a resonance capacitor, but the present disclosure is not limited thereto. A resistor R disposed between the inverter and the working coil WC can also be included in the working coil driver.

Referring to FIG. 3, some circuits of the cooking appliance 1 can be shared for each working coil driver. Some circuits shared for each working coil driver can include at least one of the power supply 110, the rectifier 120, or the DC link capacitor 130.

Unlike as illustrated in FIG. 3, the power supply 110, the rectifier 120, and the DC link capacitor 130 can be individually provided to each working coil driver.

The description of each component in FIG. 3 refers to the description provided above with reference to FIG. 2 and is not repeated herein.

FIG. 4 is a cross-sectional view illustrating a cooking appliance 1 and an object to be heated HO according to an embodiment of the present disclosure.

FIG. 5 is a cross-sectional view illustrating a cooking appliance 1 and an object to be heated HO according to another embodiment of the present disclosure.

Referring to FIGS. 4 and 5, the cooking appliance 1 can further include at least part or all of a heat insulator 35, a shielding plate 45, a support member 50, and a cooling fan 55.

The heat insulator 35 can be provided between a top plate 15 and a working coil WC. Specifically, the heat insulator 35 can be mounted under the top plate 15, and the working coil WC can be disposed under the heat insulator 35. The heat insulator 35 can block the transfer of heat, which is generated while an intermediate heater IM or an object to be heated HO is heated by the driving of the working coil WC, to the working coil WC. When the intermediate heater IM or the object to be heated HO is heated by electromagnetic induction of the working coil WC, the heat of the intermediate heater IM or the object to be heated HO is transferred to the top plate 15, and the heat of the top plate 15 is transferred back to the working coil WC. Accordingly, the working coil WC can be damaged. The heat insulator 35 blocks the transfer of the heat to the working coil WC in this way, thereby preventing the working coil WC from being damaged by heat, and furthermore, preventing the decrease in the heating performance of the working coil WC.

For reference, although not an essential component, a spacer can be installed between the working coil WC and the heat insulator 35.

The spacer can be inserted between the working coil WC and the heat insulator 35 so that the working coil WC and the heat insulator 35 do not directly contact each other. Accordingly, the spacer can block the transfer of heat, which is generated while the intermediate heater IM or the object to be heated HO is heated by the driving of the working coil WC, to the working coil WC through the heat insulator 35.

Since the spacer shares the role of the heat insulator 35, the thickness of the heat insulator 35 can be minimized, and thus, the spacing between the object to be heated HO and the working coil WC can be minimized.

In addition, a plurality of spacers can be provided. In this case, the plurality of spacers can be disposed to be spaced apart from each other between the working coil WC and the heat insulator 35. Air sucked into the case 25 by the cooling fan 55 can be guided to the working coil WC by the spacer. In other words, the spacer can improve the cooling efficiency of the working coil WC by guiding air introduced into the case 25 by the cooling fan 55 to the working coil WC.

The shielding plate 45 can be mounted under the working coil WC to block a magnetic field generated downward when the working coil WC is driven. The shielding plate 45 can be ferrite, but is not limited thereto. The shielding plate 45 can be supported upwardly by the support member 50.

The support member 50 can be installed between the bottom surface of the shielding plate 45 and the lower plate of the case 25. The support member 50 can support the shielding plate 45 upwardly, thereby indirectly supporting the heat insulator 35 and the working coil WC upwardly, and thus, the heat insulator 35 can be in close contact with the top plate 15. As a result, the distance between the working coil WC and the object to be heated HO can be kept constant.

The support member 50 can include an elastic body (for example, a spring) for supporting the shielding plate 45 upwardly, but is not limited thereto. Meanwhile, since the support member 50 is not an essential component, the support member 50 can be omitted from the cooking appliance 1.

The cooling fan 55 can be installed inside the case 25 to cool the working coil WC. The cooling fan 55 can be installed on the sidewall of the case 25. Alternatively, the cooling fan 55 can be installed in a location other than the sidewall of the case 25. The cooling fan 55 can be driven under the control of the control module described above. As illustrated in FIGS. 4 and 5, air outside the case 25 can be transferred to the working coil WC, or air (particularly, hot air) inside the case 25 can be discharged to the outside of the case 25. In this manner, efficient cooling of the components (particularly, the working coil WC) inside the case 25 is possible. The air outside the case 25 transferred to the working coil WC by the cooling fan 55 can be guided to the working coil WC by the spacer. Accordingly, direct and efficient cooling of the working coil WC is possible, thereby preventing heat damage to the working coil WC and improving durability accordingly.

The formation of one crater by using one or more working coils WC has been described above. Hereinafter, the crater is described as a “heating area or a heating region.”

The heating area is generally formed on the top plate 15 corresponding to the working coil WC in the vertical direction. When the intermediate heater IM is present, the heating area can be formed on the top plate 15 corresponding to the intermediate heater IM.

In contrast to the heating area, a “hidden heating area HHA” can refer to a new heating area formed by using a pre-formed heating area on the cooking appliance 10 without adding working coils WC and/or inverters to form heating areas.

In other words, the cooking appliance 1 according to the present disclosure can be provided with more crates, including a new crater formed through the hidden heating area HHA, that is, a hidden crater, despite the same number of working coils WC and/or the same number of inverters.

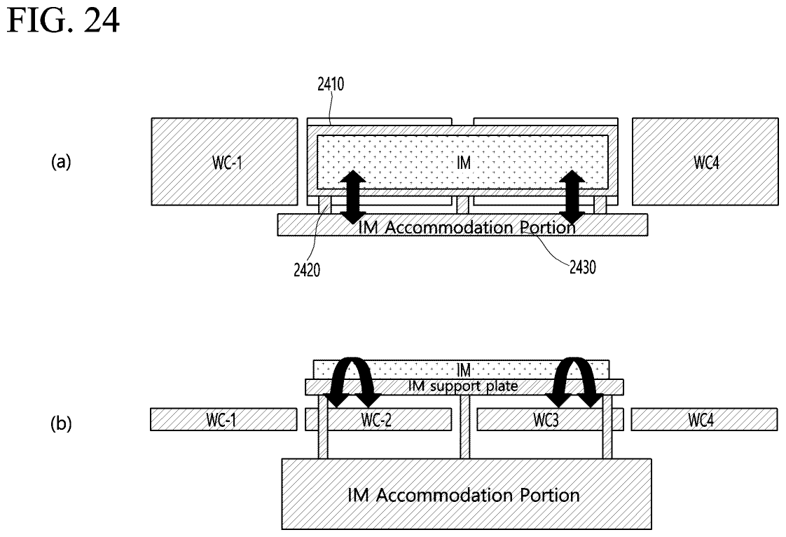

Meanwhile, for the case where the object to be heated HO is a magnetic object, a hidden crater without an intermediate heater IM can be formed on the hidden heating area HHA. For the case where the object to be heated HO is a non-magnetic object, an intermediate heater IM can be included to form a hidden crater. Meanwhile, for example, by constructing a movable intermediate heater IM as illustrated in FIG. 24 described later, the intermediate heater IM can be controlled to be positioned on the hidden heating area HHA or, conversely, can be controlled to form a hidden crater, depending on whether the object to be heated HO is a magnetic object.

A cooking appliance according to at least one of various embodiments of the present disclosure can include a top plate on which an object to be heated is placed, a plurality of working coils configured to heat the object to be heated, a plurality of inverters configured to apply current to at least one of the plurality of working coils, and a controller configured to perform control to heat the object to be heated through at least one heating area among a first heating area and a second heating area each formed at a location corresponding to a plurality of working coils and a third heating area formed at a location overlapping at least one of the plurality of working coils for the first heating area and at least one of the plurality of working coils for the second heating area.

A cooking appliance according to at least one of various embodiments of the present disclosure can include a top plate on which an object to be heated is placed, a plurality of working coils configured to heat the object to be heated, a plurality of inverters configured to apply current to at least one of the plurality of working coils, and a controller configured to perform control to heat the object to be heated through at least one heating area among a first heating area and a second heating area each formed by a plurality of working coils and a third heating area formed at a location overlapping at least one of the plurality of working coils for the first heating area and at least one of the plurality of working coils for the second heating area.

The cooking appliance according to at least one of various embodiments of the present disclosure can further include an intermediate heater disposed on the third heating area.

In the cooking appliance according to at least one of various embodiments of the present disclosure, the controller can identify a location where the object to be heated is placed and determine whether the identified location corresponds to the third heating area.

A cooking appliance according to at least one of various embodiments of the present disclosure can include a top plate on which an object to be heated is placed, a plurality of working coils for heating the object to be heated, a plurality of inverters for applying current to at least one working coil, and a controller for performing control to heat the object to be heated through at least one heating area among a first heating area and a second heating area each formed by a plurality of working coils and a third heating area formed to include a portion of the first heating area and a portion of the second heating area.

Hereinafter, the hidden heating area HHA is described in more detail with reference to the attached drawings.

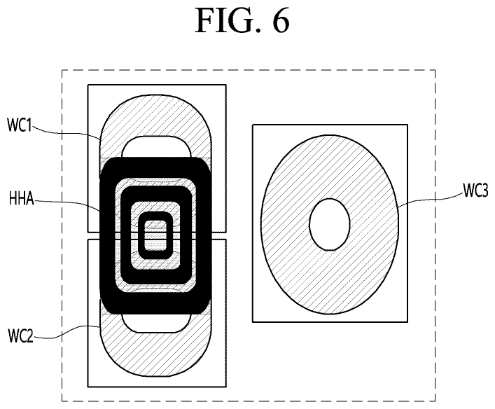

FIGS. 6 to 14 are diagrams for describing the hidden heating area HHA according to an embodiment of the present disclosure.

First, referring to FIG. 6, the cooking appliance 1 is provided with the first to third heating areas, and in particular, the third heating area, that is, the hidden heating area HHA, can be provided based on the first heating area and the second heating area.

The hidden heating area HHA can be formed between the first heating area based on the first working coil WC1 and the second heating area based on the second working coil WC20.

The hidden heating area HHA can be formed by using a portion of the first working coil WC1 and a portion of the second working coil WC2.

Meanwhile, as described above, the intermediate heater IM may or may not be present on the hidden heating area HHA.

However, for convenience of explanation, the following description is given on the assumption that the intermediate heater IM is present on the hidden heating area HHA.

Meanwhile, as described above, the hidden heating area HHA according to the present disclosure uses the existing working coil WC and inverter INV rather than uses a new working coil WC or inverter INV. Accordingly, when the hidden heating area HHA is activated, it can be necessary to perform individual control on the working coil WC for the hidden heating area HHA by using the existing inverter INV.

For example, based on the previously provided working coil WC and inverter INV, when the object to be heated HO is a magnetic object, it is necessary to perform control to minimize heat generation from the intermediate heater when the object to be heated HO is a non-magnetic object, it is necessary to perform control to maximize heat generation from the intermediate heater IM.

The intermediate heater IM can be a material having a resistance value that can be heated by the working coil WC.

The thickness of the intermediate heater IM can be inversely proportional to the resistance value (i.e., the surface resistance value) of the intermediate heater IM. For example, as the thickness of the intermediate heater decreases, the resistance value of the intermediate heater IM increases. Therefore, by thinly installing the intermediate heater IM on the top plate 15, the characteristics of the intermediate heater IM can be changed to a load that can be heated.

For example, the intermediate heater IM can have a thickness of 0.1 μm and 1,000 um, but is not limited thereto.

The intermediate heater IM is used to heat the object to be heated HO, that is, a non-magnetic object. Impedance characteristics between the intermediate heater IM and the object to be heated HO can vary depending on whether the object to be heated HO disposed on the top plate 15 is a magnetic object or a non-magnetic object.

A case where the object to be heated HO is a magnetic object is described as follows.

A resistance component R1 and an inductor component L1 of the object to be heated HO form an equivalent circuit with a resistance component R2 and an inductor component L2 of the intermediate heater IM. At this time, the impedance of the magnetic object to be heated HO (i.e., the impedance composed of R1 and L1) can be smaller than the impedance of the intermediate heater IM (i.e., the impedance composed of R2 and L2). Therefore, the magnitude of an eddy current I1 applied to the magnetic object to be heated HO can be larger than the magnitude of an eddy current I2 applied to the intermediate heater IM. Therefore, most of the eddy current generated by the working coil WC is applied to the object to be heated HO, such that the object to be heated HO is heated. In other words, when the object to be heated HO is a magnetic object, the above-described equivalent circuit is formed and most of the eddy current is applied to the object to be heated HO. Accordingly, the working coil WC can directly heat the object to be heated HO.

Next, a case where the object to be heated is a non-magnetic object is described as follows.

When the non-magnetic object to be heated HO is placed on the top plate 15 and the working coil WC is driven, no impedance may not be present in the non-magnetic object to be heated HO and the impedance can be present in the intermediate heater IM. That is, the resistance component R and the inductor component L can be present only in the intermediate heater IM. Accordingly, when the non-magnetic object to be heated HO is placed on the top plate 15 and the working coil WC is driven, the resistance component R and the inductor component L of the intermediate heater IM can form an equivalent circuit. Accordingly, the eddy current I can be applied only to the intermediate heater IM, and the eddy current may not be applied to the non-magnetic object to be heated HO.

More specifically, the eddy current I generated by the working coil WC can be applied only to the intermediate heater IM, thereby heating the intermediate heater IM. That is, when the object to be heated HO is a non-magnetic object, the eddy current I is applied to the intermediate heater IM and the intermediate heater IM is heated. Accordingly, the non-magnetic object to be heated HO can be indirectly heated by the intermediate heater IM heated by the working coil WC. In this case, the intermediate heater IM can be a main heating source.

In summary, regardless of whether the object to be heated HO is a magnetic object or a non-magnetic object, the object to be heated HO can be heated directly or indirectly by a single heat source called the working coil WC. When the object to be heated HO is a magnetic object, the working coil WC can directly heat the object to be heated HO, and when the object to be heated HO is a non-magnetic object, the intermediate heater IM heated by the working coil WC can indirectly heat the object to be heated HO.

When the object to be heated HO is a magnetic object, heating efficiency can be considered to be highest when all of the magnetic field generated from the working coil WC is combined with the object to be heated HO. On the other hand, when a portion of the magnetic field is combined with the intermediate heater IM, heating efficiency can be somewhat reduced. Therefore, when the object to be heated HO is a magnetic object, the coupling force between the magnetic field generated from the working coil WC and the intermediate heater IM can be weakly adjusted. In contrast, when the object to be heated HO is a non-magnetic object, the coupling force between the magnetic field generated from the working coil WC and the intermediate heater IM can be strongly adjusted.

The controller can control the operation of each inverter that applies current to each working coil for the hidden heating area HHA such that each working coil operates in the same phase as each other. The cooking appliance 1 can further include a relay that performs a switching operation between each working coil for the hidden heating area HHA and another working coil that receives current from the same inverter. When the hidden heating area HHA is activated, the controller can control the relay such that current is not applied to other working coils that receive current from the same inverter as each working coil for the third heating area. The plurality of working coils for the hidden heating area HHA can receive current from different inverters. The plurality of working coils for the hidden heating area HHA can receive current from individual inverters. The controller can perform control such that the respective inverters that apply current to the working coils forming the hidden heating area HHA operate in the same operating frequency having opposite phases.

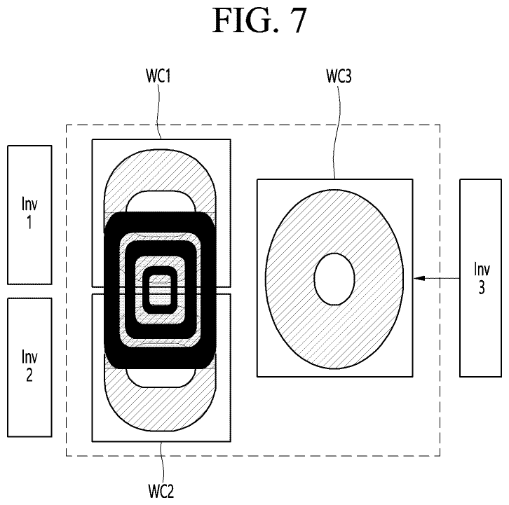

Referring to FIG. 7, the first heating area can be formed by the first working coil WC1 and the first inverter INV1, the second heating area can be formed by the second working coil WC2 and the second inverter INV2, and the third heating area can be formed by the third working coil WC3 and the third inverter INV3.

Meanwhile, the hidden heating area HHA can be formed between the first heating area and the second heating area, that is, a portion of the first heating area and a portion of the second heating area. Therefore, in order to activate the hidden heating area HHA, the first working coil WC1 can be controlled through the first inverter INV1, and the second working coil WC2 can be controlled through the second inverter INV2. At this time, since the intermediate heater IM is present on the hidden heating area HHA, the first working coil WC1 and the second working coil WC2 can be controlled such that the heat generation of the intermediate heater IM is maximized.

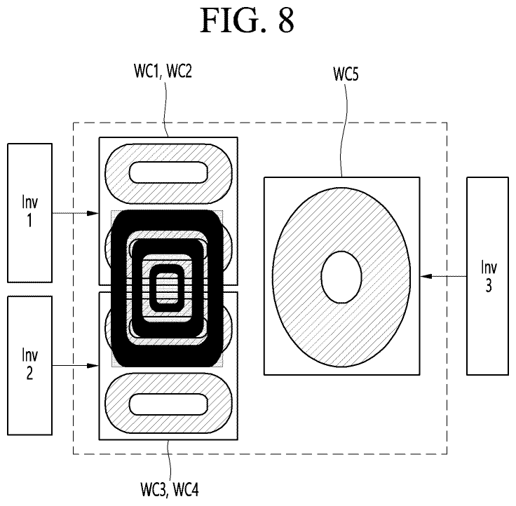

In FIG. 8, unlike in FIG. 7, a first heating area can be formed by a first working coil WC1, a second working coil WC2, and a first inverter INV1, a second heating area can be formed by a third working coil WC3, a fourth working coil WC4, and a second inverter INV2, and a third heating area can be formed by a fifth working coil WC5 and a third inverter INV3.

Meanwhile, the hidden heating area HHA can be formed between the first heating area and the second heating area, that is, a portion of the first heating area and a portion of the second heating area. Therefore, in order to activate the hidden heating area HHA, the second working coil WC2 can be controlled through the first inverter INV1, and the third working coil WC3 can be controlled through the second inverter INV2. At this time, since the intermediate heater IM is present on the hidden heating area HHA, the second working coil WC2 can be controlled through the first inverter INV1 and the third working coil WC3 can be controlled through the second inverter INV2, so that the heat generation of the intermediate heater IM is maximized.

In the case of FIG. 7, in order to activate the hidden heating area HHA, the first inverter INV1 and the second inverter INV2 are controlled such that only the second working coil WC2 and the third coil WC3 operate. However, as illustrated, for example, the first inverter INV1 may need to operate the first working coil WC1 in order for the second working coil WC2 to operate. Therefore, this can reduce efficiency.

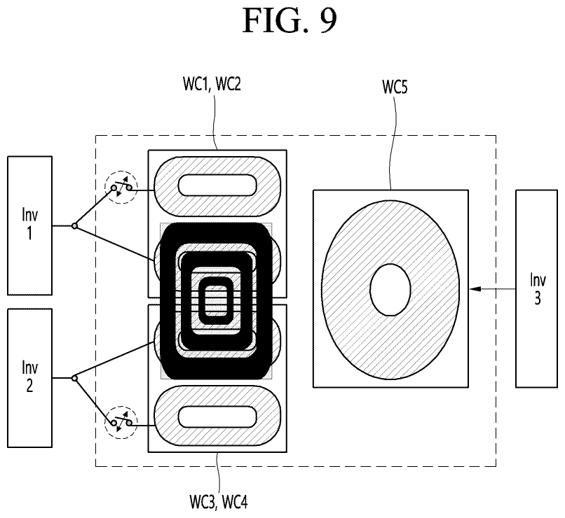

On the other hand, FIGS. 9 to 14 disclose various embodiments to solve the same problems as in FIG. 7. For convenience of explanation, the description of the third heating area is omitted below with reference to the above description.

In FIG. 9, similarly to FIG. 8, the first inverter INV1 controls the first working coil WC1 and the second working coil WC2, and the second inverter INV2 controls the third working coil WC3 and the fourth working coil WC4. At this time, in FIG. 8, the first inverter INV1 has to always control the first working coil WC1 and the second working coil WC2 to be turned on or off together. However, in FIG. 9, the first working coil WC1 and the second working coil WC2 can be individually controlled by the first inverter INV1. That is, in FIG. 9, only the first working coil WC1 can be individually controlled to be turned on or off through the first inverter INV1. For this purpose, the cooking appliance 1 can be provided with a switching means between the first inverter INV1 and the first working coil WC1. The switching means includes a relay, a switch, etc., such that an electrical switching operation is performed. The above description can be directly applied to the second inverter INV2.

That is, when the hidden heating area HHA is activated, the cooking appliance 1 can perform control to disconnect the electrical connection with the first working coil WC1 and activate only the second working coil WC2 through the first inverter INV1, can perform control to activate the third working coil WC3 through the second inverter INV2, and can perform control to disconnect the electrical connection with the fourth working coil WC40. Therefore, when the hidden heating area HHA is activated, only the second working coil WC2 and the third working coil WC3 can be activated through the first inverter INV1 and the second inverter INV2 to maximize the heat generation of the intermediate heater IM.

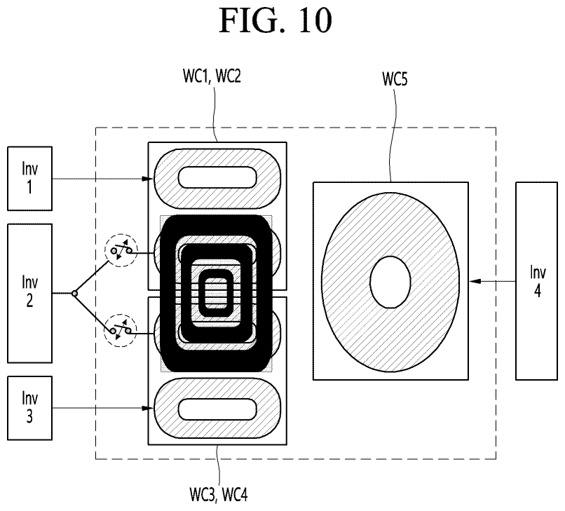

Referring to FIG. 10, the cooking appliance 1 can include a total of four heating areas, including the hidden heating area HHA, five inverters, and five working coils.

The first heating area can be formed by the first working coil WC1 and the second working coil WC2, the first working coil WC1 can be controlled by the first inverter INV1, and the second working coil WC2 can be controlled by the second inverter INV2.

The second heating area can be formed by the third working coil WC3 and the fourth working coil WC4, the third working coil WC3 can be controlled by the second inverter INV2, and the fourth working coil WC4 can be controlled by the third inverter INV3.

The third heating area can be formed by the fifth working coil WC5 controlled by the fourth inverter INV4.

Meanwhile, the hidden heating area HHA can be formed by the second working coil WC2 and the third working coil WC3 controlled by the second inverter INV2.

The switching means can be provided between the second inverter INV2 and the second working coil WC2 and between the second inverter INV2 and the third working coil WC3 and can be controlled simultaneously or individually.

For example, when the hidden heating area HHA is activated, the first inverter INV1 and the third inverter INV3 can be turned off, the second inverter INV2 can be turned on, and each switching means provided between the second inverter INV2 and the second working coil WC2 and between the second inverter INV2 and the third working coil WC3 can be electrically connected.

On the other hand, when the hidden heating area HHA is not activated, that is, when only the first heating area is used, the first inverter INV1 and the second inverter INV2 can be turned on, the third inverter INV3 can be turned off, the switching means provided between the second inverter INV2 and the second working coil WC2 can be electrically connected, and the switching means provided between the second inverter INV2 and the third working coil WC3 may not be electrically connected. The above description can be applied even when only the second heating area is used. Meanwhile, when the first heating area and the second heating area are used simultaneously, all of the above-described switching means can be electrically connected to the second inverter INV2.

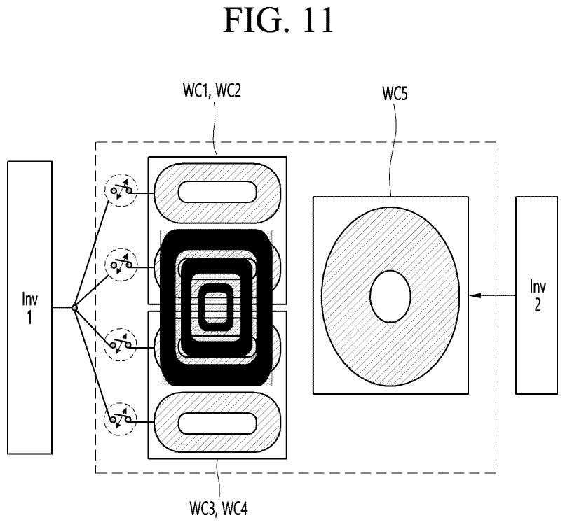

Referring to FIG. 11, the cooking appliance 1 can include a total of four heating areas, including the hidden heating area HHA, two inverters, and five working coils.

The first heating area can be formed by the first working coil WC1 and the second working coil WC2 controlled by the first inverter INV1.

The second heating area can be formed by the third working coil WC3 and the fourth working coil WC4 controlled by the first inverter INV1.

The third heating area can be formed by the fifth working coil WC5 controlled by the second inverter INV2.

Meanwhile, the hidden heating area HHA can be formed by the second working coil WC2 and the third working coil WC3 controlled by the first inverter INV1.

The switching means can be provided between the first inverter INV1 and the first to fourth working coils WC1 to WC4 and can be controlled simultaneously or individually.

For example, when the hidden heating area HHA is activated, the first inverter INV1 can be turned on, only two switching means provided between the first inverter INV1 and the second working coil WC2 and between the first inverter INV1 and the third working coil WC3 can be electrically connected, and the switching means provided between the remaining working coils may not be electrically connected.

On the other hand, when the hidden heating area HHA is not activated, that is, depending on the heating area that is activated, only the switching means provided between the corresponding working coils in the first inverter INV1 can be electrically connected and controlled to be turned on.

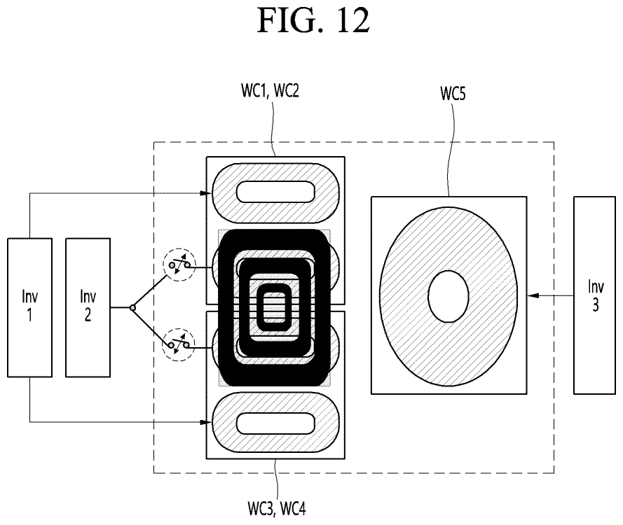

Referring to FIG. 12, the cooking appliance 1 can include a total of four heating areas, including the hidden heating area HHA, three inverters, and five working coils.

At this time, the first inverter INV1 can control only the first working coil and the fourth working coil, and the second inverter INV2 can control only the second working coil and the third working coil.

The first heating area can be formed by the first working coil WC1 controlled by the first inverter INV1 and the second working coil WC2 controlled by the second inverter INV2.

The second heating area can be formed by the third working coil WC3 controlled by the second inverter INV2 and the fourth working coil WC4 controlled by the first inverter INV1.

The third heating area can be formed by the fifth working coil WC5 controlled by the third inverter INV3.

Meanwhile, the hidden heating area HHA can be formed by the second working coil WC2 and the third working coil WC3 controlled by the second inverter INV2.

The switching means can be provided between the second inverter INV2 and the second and third working coils WC2 to WC3 and can be controlled simultaneously or individually.

For example, when the hidden heating area HHA is activated, the first inverter INV1 can be turned off, the second inverter INV2 can be turned on, and two switching means provided between the second inverter INV2 and the second working coil WC2 and between the second inverter INV2 and the third working coil WC3 can be electrically connected.

On the other hand, when the hidden heating area HHA is not activated, that is, depending on the heating area that is activated, at least one of the switching means provided between the corresponding working coils in the second inverter INV2 can be electrically connected and controlled to be turned on. For example, when only the first heating area is activated, the switching means provided between the second inverter INV2 and the second working coil WC2 can be electrically connected, and the switching means provided between the second inverter INV2 and the third working coil WC3 may not be electrically connected. Similarly, when only the second heating area is activated, the switching means provided between the second inverter INV2 and the third working coil WC3 can be electrically connected, and the switching means provided between the second inverter INV2 and the second working coil WC2 may not be electrically connected. On the other hand, when both the first heating area and the second heating area are activated, all switching means provided between the second inverter INV2 and the second working coil WC2 and between the second inverter INV2 and the third working coil WC3 can be electrically connected.

Meanwhile, referring to FIG. 13, the cooking appliance 1 can include a total of four heating areas, including the hidden heating area HHA, five inverters, and five working coils.

At this time, each inverter can control only one working coil, that is, a single working coil.

Therefore, the first heating area can be formed by the first working coil WC1 controlled by the first inverter INV1 and the second working coil WC2 controlled by the second inverter INV2.

The second heating area can be formed by the third working coil WC3 controlled by the third inverter INV3 and the fourth working coil WC4 controlled by the fourth inverter INV4.

The third heating area can be formed by the fifth working coil WC5 controlled by the fifth inverter INV5.

Meanwhile, the hidden heating area HHA can be formed by the second working coil WC2 controlled by the second inverter INV2 and the third working coil WC3 controlled by the third inverter INV3.

For example, when the hidden heating area HHA is activated, the first inverter INV1 and the fourth inverter INV4 can be turned off, and the second inverter INV2 and the third inverter INV3 can be turned on.

On the other hand, when the hidden heating area HHA is not activated, the inverters corresponding to the activated heating area and the working coils controlled thereby can be turned on.

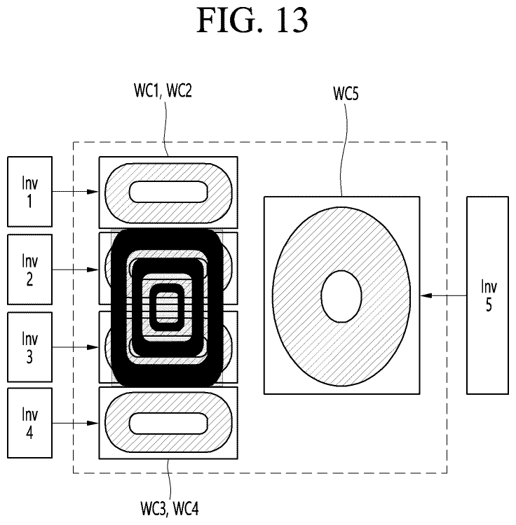

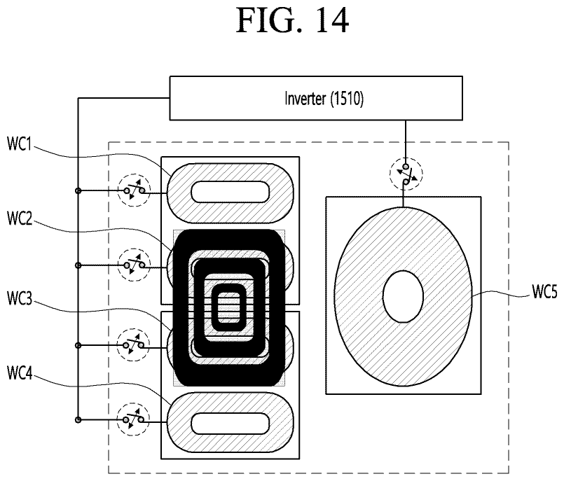

On the other hand, referring to FIG. 14, the cooking appliance 1 can include a total of four heating areas, including the hidden heating area HHA, one inverter, and five working coils.

At this time, the switching means can be provided between each working coil and the inverter 1510.

Therefore, the first heating area can be formed by the first working coil WC1 and the second working coil WC2 controlled by the first inverter INV1.

The second heating area can be formed by the third working coil WC3 and the fourth working coil WC4 controlled by the first inverter INV1.

The third heating area can be formed by the fifth working coil WC5 controlled by the first inverter INV1.

Meanwhile, the hidden heating area HHA can be formed by the second working coil WC2 and the third working coil WC3 controlled by the first inverter INV1.

For example, when the hidden heating area HHA is activated, only the switching means provided between the first inverter INV1 and the second working coil WC2 and between the first inverter INV1 and the third working coil WC3 can be electrically connected, and the switching means provided between the remaining working coils may not be electrically connected.

On the other hand, when the hidden heating area HHA is not activated, only the switching means provided between the working coils corresponding to the activated heating area can be electrically connected.

FIG. 15 is a diagram illustrating an object to be heated HO, which is placed on a cooking appliance 1 according to an embodiment of the present disclosure.

In FIG. 15, for convenience of explanation, only three heating areas, including a hidden heating area HHA, and four working coils WC are shown.

However, the hidden heating area HHA may not be activated in parts (a) to (d) of FIG. 15, and the hidden heating area HHA can be activated only in part (c) of FIG. 15.

In parts (a) to (c) of FIG. 15, when defining working coils as the first to fourth working coils WC1 to WC4 from above, a first heating area is formed by the first working coil WC1 and the second working coil WC2, a second heating area is formed by the third working coil WC3 and the fourth working coil WC4, and a third heating area, that is, a hidden heating area HHA, is formed by the second working coil WC2 and the third working coil WC3. At this time, as described above, the intermediate heater IM can be disposed on the hidden heating area HHA.

In part (a) of FIG. 15, the object to be heated HO is placed on the first heating area, and in this case, the hidden heating area HHA may not be activated.

In part (b) of FIG. 15, the object to be heated HO is placed on the second heating area, and in this case, the hidden heating area HHA may not be activated.

In part (c) of FIG. 15, two objects to be heated HO are respectively placed on the first heating area and the second heating area, and in this case, the hidden heating area HHA may not be activated.

In part (d) of FIG. 15, the object to be heated HO, whose width is very large enough to cover both the first heating area and the second heating area, is placed, and in this case, the hidden heating area HHA may not be activated.

In part (e) of FIG. 15, the object to be heated HO is placed on the hidden heating area HHA, and the hidden heating area HHA can be activated.

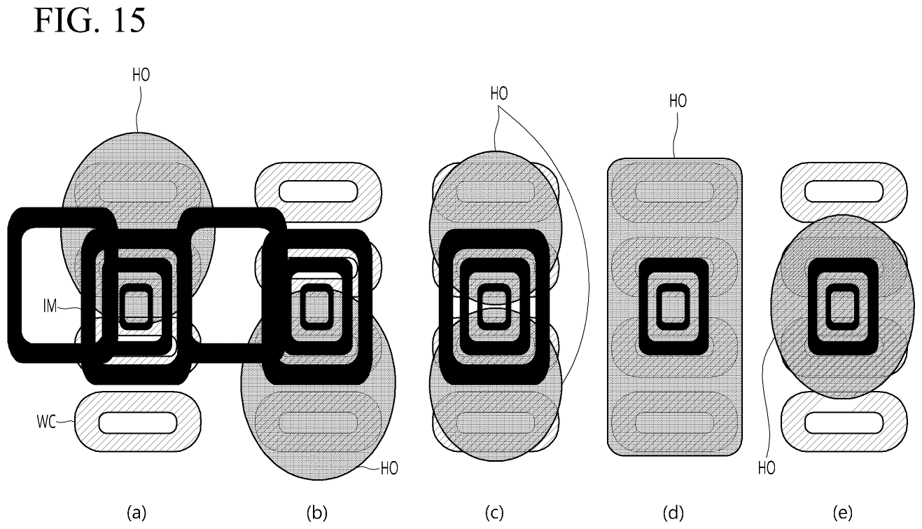

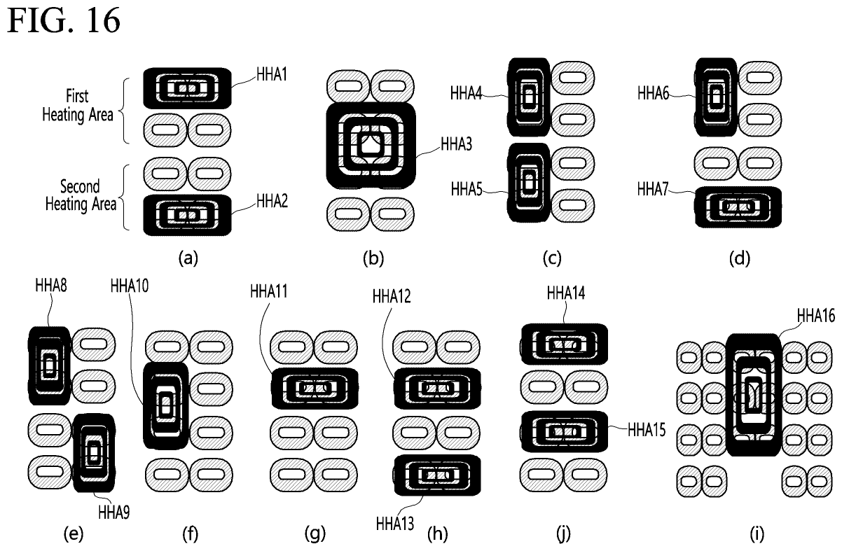

FIG. 16 is a diagram for describing a top view of heating areas including a hidden heating area HHA according to an embodiment of the present disclosure.

The hidden heating area HHA of the present disclosure basically forms an additional heating area without adding a working coil WC and/or an inverter INV. Therefore, the hidden heating area HHA according to the present disclosure can be variously formed depending on the arrangement of the working coil WC.

Referring to parts (a) to (i) of FIG. 16, the arrangement of the working coils is two columns and four rows, that is, at least two working coils WC are arranged adjacent to each other in the horizontal direction (two columns) and arranged in the vertical direction (four rows). On the other hand, referring to part (j) of FIG. 16, the working coils are arranged in six columns and four rows. However, parts (a) to (j) of FIG. 16 are merely examples, and the present disclosure is not limited thereto.

In parts (a) to (i) of FIG. 16, the upper four working coils can form one heating area (the first heating area) and the remaining four lower working coils can form another heating area (the second heating area).

Referring to part (a) of FIG. 16, two working coils in the first row within the first heating area can form one hidden heating area (a first hidden heating area HHA1), and the two working coils in the fourth row can form another hidden heating area (a second hidden heating area HHA2).

Referring to part (b) of FIG. 16, two working coils in the second row within the first heating area and two working coils in the third row within the second heating area can form one hidden heating area (a third hidden heating area HHA3).

Referring to part (c) of FIG. 16, two working coils in the first row within the first heating area can form one hidden heating area (a fourth hidden heating area HHA4), and two working coils in the first row within the second heating area can form another hidden heating area (a fifth hidden heating area HHA5).

Referring to part (d) of FIG. 16, two working coils in the first row within the first heating area can form one hidden heating area (a sixth hidden heating area HHA6), and two working coils in the fourth row within the second heating area can form another hidden heating area (a seventh hidden heating area HHA7).

Referring to part (e) of FIG. 16, two working coils in the first row within the first heating area can form one hidden heating area (an eighth hidden heating area HHA8), and two working coils in the second row within the second heating area can form another hidden heating area (a ninth hidden heating area HHA9).

Referring to part (f) of FIG. 16, one working coil in the first row and the second row within the first heating area and one working coil in the first row and the third row within the second heating area can form one hidden heating area (a tenth hidden heating area HHA10).

Referring to part (g) of FIG. 16, two working coils in the second row within the first heating area can form one hidden heating area (an eleventh hidden heating area HHA11).

Referring to part (h) of FIG. 16, two working coils in the second row within the first heating area can form one hidden heating area (a twelfth hidden heating area HHA12), and two working coils in the fourth row within the second heating area can form another hidden heating area (a thirteenth hidden heating area HHA13).

Referring to part (i) of FIG. 16, two working coils in the first row within the first heating area can form one hidden heating area (a fourteenth hidden heating area HHA14), and two working coils in the fourth row within the second heating area can form another hidden heating area (a fifteenth hidden heating area HHA15).

Meanwhile, referring to part (j) of FIG. 16, one hidden heating area (a sixteenth hidden heating area HHA16) can be formed on a total of six working coils in the third and fourth columns among a total of 24 working coils arranged in the sixth column and the third or fourth row in the cooking appliance 1.

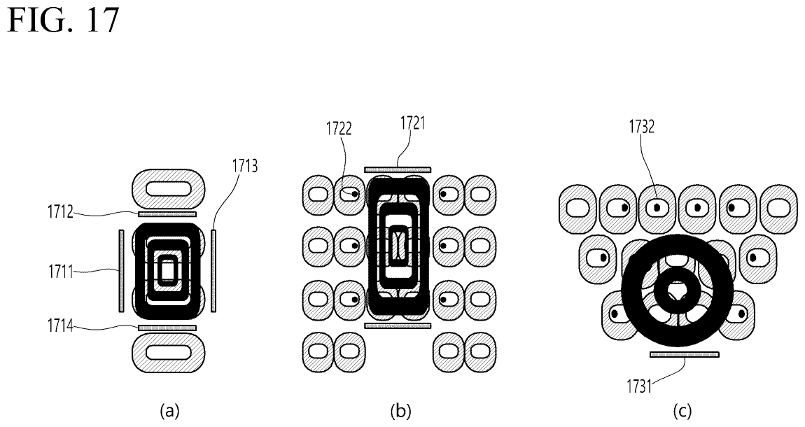

FIG. 17 is a diagram for describing a method for identifying a hidden heating area HHA formed in a cooking appliance 1 according to an embodiment of the present disclosure.

FIG. 17 discloses a cooking appliance 1 including a means (hereinafter referred to as an indicator) for allowing a user to more easily recognize or identify the hidden heating area(s) disclosed in FIGS. 6 to 16 described above.

In the present specification, at least one of an LED or an LED array can be used as an indicator. However, the present disclosure is not limited thereto.

The cooking appliance according to at least one of various embodiments of the present disclosure can further include a diffusion plate that is disposed between the top plate and the indicator and extends in the longitudinal direction up to the top plate to diffuse the emitted light such that the light is exposed to the outside through the top plate. The indicator can be disposed around at least one working coil WC forming the third heating area. The indicator can include an LED element, an LED array, and a speaker.

In the present disclosure, the indicator can be activated in least one of a case where the presence or absence of the hidden heating area HHA is indicated before the object to be heated HO is placed on the hidden heating area HHA, a case where the object to be heated HO is placed on the hidden heating area HHA, a case where the hidden heating area HHA is activated after the object to be heated HO is placed on the hidden heating area HHA, or a case where an event occurs in the hidden heating area HHA. In a case where the presence or absence of the hidden heating area HHA is indicated before the object to be heated HO is placed on the hidden heating area HHA, the indicator can be activated, for example, when the user operates an interface provided on the cooking appliance 1, when a separate detection sensor is present on the cooking appliance 1, and the user is detected on or around the object to be heated HO, and the like. The event can include, for example, an error or failure of the hidden heating area HHA, the occurrence of high heat above a predetermined value after activation, or the possibility of a fire occurring as a result.

First, referring to part (a) of FIG. 17, indicators 1711 to 1714 are arranged around the hidden heating area HHA formed on the second working coil WC2 and the third working coil WC3. The indicators 1711-1714 can consist of LED arrays.

Referring to part (b) of FIG. 17, indicators 1721 and 1722 are arranged around the hidden heating area HHA. Some indicators 1721 can be implemented as an LED array, and the remaining indicators can be implemented as LEDs. In the latter case, each LED indicator can be placed on the working coil WC arranged around the hidden heating area HHA. However, in this case, as illustrated, each LED indicator and the working coil WC may not overlap each other in the vertical direction.

Referring to part (c) of FIG. 17, similarly, indicators 1731 and 1732 are arranged around the hidden heating area HHA. However, some indicators 1731 can be implemented as an LED array, and the remaining indicators can be implemented as LEDs. In the latter case, each LED indicator can be placed on the working coil WC arranged around the hidden heating area HHA, and each LED indicator and the working coil WC may not overlap each other in the vertical direction.

Meanwhile, in part (c) of FIG. 17, unlike as described above, the hidden heating area HHA can be formed in a circular or oval shape. In other words, the hidden heating area disclosed in various embodiments of the present disclosure is not necessarily limited to, for example, a polygonal shape (in this case, each corner can be rounded) and can have various shapes, such as a circular or oval shape.

Hereinafter, the cross-sectional view of the cooking appliance 1 is disclosed in relation to the location or arrangement of the indicator within the cooking appliance 1.

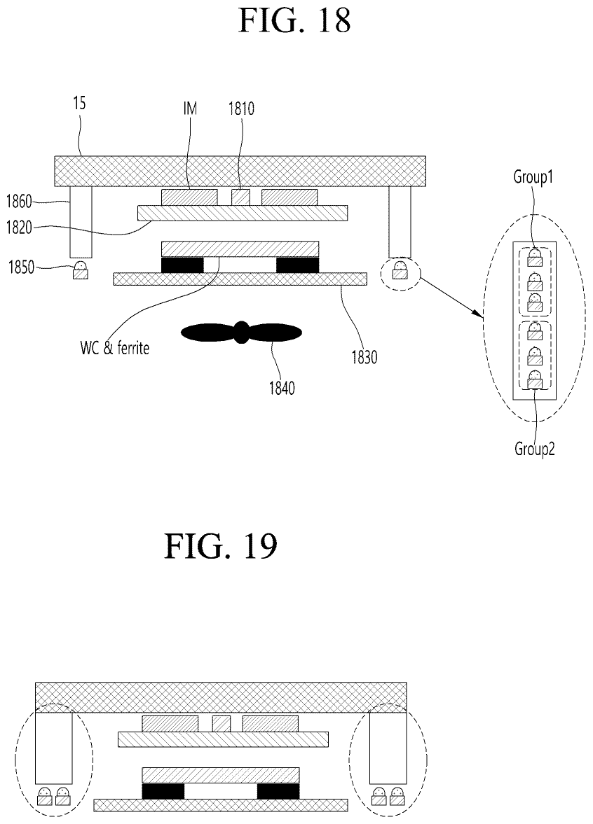

FIGS. 18 to 23 are cross-sectional views illustrating the cooking appliance 1 including the indicator according to an embodiment of the present disclosure.

Looking at the cross-sectional views of the cooking appliance 1 with reference to FIG. 18, an intermediate heater IM and a sensor 1810 can be disposed below a top plate 15, and a heat insulator 1820 can be disposed below the top plate 15. The sensor 1810 can include a temperature sensor, a container detection sensor, etc.

A working coil and ferrite can be disposed under the heat insulator 1820, a plate 1830 can be disposed below the heat insulator 1820, and a fan 1840 can be disposed at the lowermost portion. The plate 1830 can include an aluminum (Al) plate.

The indicator according to the present disclosure can be disposed at both ends, that is, the left end and the right end in the cross-sectional view.

The indicator can include an LED element 1850 and a diffusion plate 1860.

The LED element 1850 can be implemented in the form of a single light emitting element or an array. As illustrated in FIG. 18, when the LED element 1850 is implemented in the form of an array, at least two light emitting elements can form one group. The light emitting elements can be controlled individually or in units of groups.

The LED element 1850 can be disposed at a predetermined location within the lower portion of the top plate 15, and the diffusion plate 1860 can be disposed on the top of the LED element 1850 and extend up to the lower portion of the top plate 15. Accordingly, light emitted from the LED element 1850 can be recognized through the top plate 15 and the diffusion plate 1860.

In the cross-sectional view of FIG. 18, the LED element 1850 is illustrated as being disposed below the heat insulator 1820 and at the same depth as or above the plate 1840, but the arrangement is not limited thereto.

Meanwhile, the LED element formed at one end can be a single light emitting element, and the LED element formed at the other end can be in the form of an LED array.

In FIG. 19, in addition to FIG. 18, the number of LED elements formed in each stage has been added. Additionally, the width of the diffusion plate can be changed (e.g., enlarged) to facilitate diffusion of light emitted by additional LED elements.

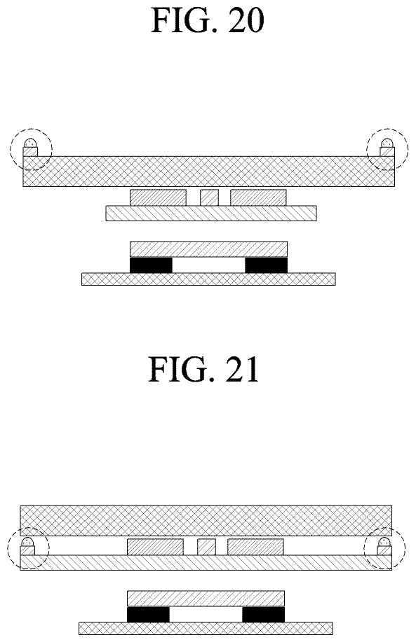

In FIG. 20, the LED element can be formed on the top plate 15, unlike in FIGS. 18 and 19. Therefore, in this case, a diffuser plate may not be required.

In FIG. 21, the LED element can be arranged to directly contact the lower portion of the top plate 15, unlike in FIG. 20. In this case, in order to support the LED element, for example, a heat insulator can extend in the horizontal direction, compared to FIG. 18 or 19, and the LED element can be disposed thereon. Even in this case, since the LED element is in contact with the lower portion of the top plate 15, a separate diffusion plate may not be required. Since a groove is provided on the bottom surface of the top plate 150 in which the LED element is disposed or which is in contact with the LED element, it can replace the diffuser plate or serve as the diffuser plate and can also support the LED element to be fixed through the groove.

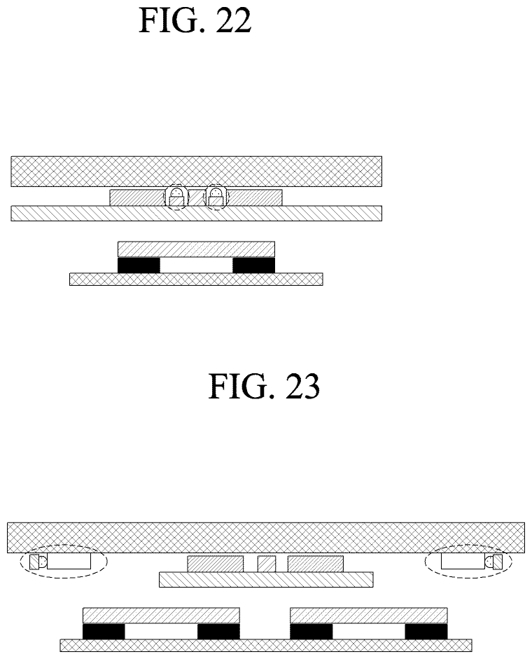

FIG. 22 is similar to FIG. 21, but differs from FIG. 21 in that the LED element can be disposed inside (or between) the intermediate heater(s) IM. Additionally, the LED element can be disposed around the sensor 1810. That is, the LED element can be disposed in a space between the intermediate heater IM and the sensor 1810. At this time, in order to secure sufficient arrangement space and minimize the influence of activation of the intermediate heater IM, the space between the intermediate heater IM and the sensor 1810 can be larger than in the previous drawings. This can be implemented by increasing the size of the intermediate heater IM or by reducing the size of the sensor 1810. In a similar way, the size of the LED element can be reduced.

In FIG. 23, the LED element is disposed as far away from the intermediate heater IM or the working coil as possible. Accordingly, light emitted by the LED element located on the outside can be exposed at a desired location by using the diffusion plate while minimizing the resulting influence. In FIG. 23, unlike in FIGS. 18 to 22 described above, the light emitting direction of the LED element is implemented to be directed inward in the horizontal direction in the cross-sectional view.

The indicators disclosed in FIGS. 18 to 23 are merely examples of the present disclosure and are not limited thereto.

FIG. 24 is a diagram illustrating a movable intermediate heater IM according to an embodiment of the present disclosure.

FIG. 24 discloses the structure of the movable intermediate heater IM.

Part (a) of FIG. 24 illustrates the working coils and the movable intermediate heater IM when viewed from above, and part (b) of FIG. 24 illustrates an example of the working coils and the movable intermediate heater IM when viewed from the side. For example, the movable intermediate heater IM can be stowed away within the accommodation portion 2430 when the movable intermediate heater IM is not needed or not in use. However, when a user desires to use the movable intermediate heater IM (e.g., when cooking with a non-magnetic pan), then the movable intermediate heater IM can swing out from the accommodation portion 2430 or be deployed to overlap with one or more of the working coils.

Referring to parts (a) and (b) of FIG. 24, four working coils WC1 to WC4 can be arranged horizontally, and the intermediate heater IM can be disposed on a second working coil WC2 and a third working coil WC3 constituting a hidden heating area HHA.

A support portion or support frame 2420 (hereinafter referred to as a ‘support portion’) can be connected to one end of the intermediate heater IM, and the support portion 2420 can be connected to one end of an accommodation portion 2430 that can accommodate the intermediate heater IM.

An intermediate heater support plate can be provided at the lower portion of the intermediate heater IM. The support portion 2420 can be connected to one end of the intermediate heater support plate rather than the intermediate heater IM. The support portion can allow the intermediate heater IM to be seated on or detached from an intermediate heater accommodation portion 2430 through the connected intermediate heater support plate and disposed on the working coils WC2 and WC3.

According to an embodiment of the present disclosure, there is an advantage of improving heating efficiency for each container material and increasing output performance by controlling heat generation of the intermediate heater depending on the type of the object to be heated.

According to an embodiment of the present disclosure, there is an effect of simplifying a control logic in that output performance is improved by selectively operating the plurality of working coils during one cycle without the need to control the phases of the plurality of working coils.

According to an embodiment of the present disclosure, there is an effect of increasing the number of heating areas by providing the hidden heating area in addition to the preset heating area, thereby increasing the degree of freedom of the container, and being capable of heating with high efficiency regardless of the container material when heating the object to be heated placed at the installation location of the intermediate heater.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of the present disclosure should be interpreted by the appended claims, and all technical ideas within the scope equivalent thereto should be construed as falling within the scope of the present disclosure.

What is claimed is:

1. A cooking appliance comprising:
a top plate configured to support an object to be heated;
a plurality of working coils configured to heat the object;
a plurality of inverters configured to apply current to at least one of the plurality of working coils; and
a controller configured to heat the object via at least one heating area among a first heating area, a second heating area and a third heating area,
wherein the first heating area corresponds to at least a first working coil among the plurality of working coils, the second heating area corresponds to at least a second working coil among the plurality of working coils, and the third heating area corresponds to a third working coil among the plurality of working coils.

2. The cooking appliance of claim 1, further comprising an intermediate heater configured to overlap with the third heating area,
wherein the intermediate heater includes a magnetic material configured to be heated by the third working coil.

3. The cooking appliance of claim 2, wherein the intermediate heater is coated on an area of the top plate corresponding to the third heating area.

4. The cooking appliance of claim 2, wherein the controller is further configured to apply current to each of the plurality of working coils via the plurality of inverters so that the plurality of working coils operate in a same phase.

5. The cooking appliance of claim 2, further comprising a relay configured to perform a switching operation between at least the third working coil for the third heating area and another working coil among the plurality of working coils configured to receive current from a same inverter among the plurality of inverters.

6. The cooking appliance of claim 5, wherein the controller is further configured to activate the third heating area by suppling current to the third working coil via the relay while current is not applied to other working coils configured to receive current from the same inverter.

7. The cooking appliance of claim 1, wherein a group of two or more working coils among the plurality of working coils corresponding to the third heating area are configured to receive current from different inverters among the plurality of inverters.

8. The cooking appliance of claim 1, wherein a group of two or more working coils among the plurality of working coils corresponding to the third heating area are configured to respectively receive current from individual inverters among the plurality of inverters.

9. The cooking appliance of claim 1, wherein the controller is further configured to apply current to a group of two or more working coils among the plurality of working coils corresponding to the third heating area to operate in a same operating frequency having opposite phases.

10. The cooking appliance of claim 1, wherein the controller is further configured to detect a location corresponding to the object and determine whether the identified location corresponds to the third heating area.

11. The cooking appliance of claim 10, further comprising a diffusion plate disposed between the top plate and an indicator configured to emit light, the diffusion plate extending toward the top plate in a longitudinal direction to diffuse the light so that the light is exposed through the top plate.

12. The cooking appliance of claim 10, wherein the indicator is disposed around at least one working coil corresponding to the third heating area.

13. The cooking appliance of claim 10, wherein the indicator includes at least one of a light emitting diode (LED) element, an LED array, and a speaker.

14. The cooking appliance of claim 1, further comprising an indicator configured to emit light, the indicator being disposed around at least one working coil among the plurality of working coils.

15. A cooking appliance comprising:
a top plate configured to support an object to be heated;
a plurality of working coils configured to heat the object;
a plurality of inverters configured to apply current to at least one of the plurality of working coils; and
a controller configured to heat the object through at least one heating area among a first heating area and a second heating area each formed by some of the plurality of working coils and a third heating area including a portion of the first heating area and a portion of the second heating area.

16. A cooking appliance comprising:
a top plate configured to support an object to be heated;
a plurality of working coils configured to heat the object;
an intermediate heating member including a magnetic material;
one or more inverters configured to apply current to at least one of the plurality of working coils; and
a controller configured to:
heat a first heating area corresponding to a first working coil among the plurality of working coils,
heat a second heating area corresponding to a second working coil among the plurality of working coils, and
heat the intermediate heating member via at least a portion of the first working coil or at least a portion of the second working coil.

17. The cooking appliance of claim 16, wherein the controller is further configured to move the intermediate heating member from a first position that does not overlap with any of the plurality of working coils in a vertical direction to a second portion that overlaps with at least one of the plurality of working coils in the vertical direction.

18. The cooking appliance of claim 16, further comprising an accommodation portion configured to stow the intermediate heating member while the intermediate heating member is not in use.

19. The cooking appliance of claim 16, wherein the controller is further configured to move the intermediate heating member from a stowed position to overlap with both of the first working coils and the second working coil.
